(19) United States
(12) Patent Application Publication
(10) Pub. No.: US 2026/0261122 A1
(43) Pub. Date: Sep. 3, 2026

(54) METHODS, SYSTEMS AND APPARATUS FOR MANAGEMENT OF ELECTRICITY IN A HIERARCHICAL POWER DISTRIBUTION NETWORK

(71) Applicant: VARIABLEGRID ADAPTIVE POWER INC., NORTH VANCOUVER (CA)

(72) Inventors: GREGORY MERRICK, NORTH VANCOUVER (CA); DANIEL LAFFERTY, NORTH VANCOUVER (CA)

(21) Appl. No.: 19/549,891

(22) Filed: Feb. 25, 2026

Related U.S. Application Data
(60) Provisional application No. 63/764,619, filed on Feb. 28, 2025.

(51) Int. Cl. H02J 3/17; B60L 53/63; H02J 3/38

(52) U.S. Cl. CPC H02J 3/17; B60L 53/63; H02J 3/38

(57) ABSTRACT

There is provided controllers, methods and systems to allocate power (current) for use in a hierarchical power distribution network. A power distribution method allocates power proportionally based on load demand for variable loads, such as EV charging, as aggregated from distribution points and any power reserve available to allocate for such points. The allocation is constrained in accordance with electrical constraints of each of the respective distribution points for safe allocation. Parent and child controllers are shown and described, with feature configurable in each for easy installation and start up. A publish/subscribe protocol provides automatic network establishment. Systems and methods are applicable to various topologies including those at residential complexes (townhouses), campus and major venues.

### CROSS-REFERENCE

The present application claims a domestic benefit of U.S. 63/764,619, filed 28 Feb. 2025, which is incorporated herein by reference in its entirety where permitted.

### FIELD OF THE INVENTION

The present disclosure relates to allocating current in a multi-level electrical system having multiple distributors (distribution points) that have a maximum rated current capacity, among a plurality of load circuits, including a variable load circuit that benefits from a full load current allocation but is operable at a lower current allocation, for example a charging circuit for an electric vehicle battery.

### BACKGROUND OF THE INVENTION

Power management for electric vehicle (EV) charging infrastructure in complex, multi-level electrical systems is a present challenge, with growth expectations. Multi-level electrical systems include systems for townhouse complexes where multiple dwellings are respectively serviced. In an example topology of a system, a top-level distribution point (an electrical feeder) provides service to a plurality of respective low level distribution points (e.g. respective townhouse panels) so that each townhouse receives electrical service. Other residential or non-residential property types may also have multi-level distribution systems, and a multi-level system may have two or more levels.

Each distribution point in the multi-level system has a maximum rated current capacity. It may be desirable that distribution points at a lower level(s) have an aggregated maximum rated current capacity that exceeds the maximum rated current capacity of the distribution point in a higher level through which service is provided to the lower level(s).

In the townhouse example, at least some townhouse panels allocate current via a plurality of load circuits to provide service through a variable load circuit to a variable load (also referenced as a controlled load) that benefits from a full load current allocation but is operatable at lower current allocation. An example of a variable load is a charger for EV battery charging. In the example, such a townhouse panel also allocates current via load circuits to service uncontrolled loads (fixed loads) such as for other occupant needs.

U.S. Pat. No. 8,314,511B2, assigned to the present applicant and incorporated herein by reference, relates to allocation of power to EV chargers in a topology in which the top level is monitored using current sensors and the sensor readings are used to impose top-level constraints on the topology.

It is desired to provide a power management system for managing multiple level power distribution systems.

### SUMMARY

By leveraging a hierarchical approach, the embodiments (whether method or apparatus) herein provide a comprehensive solution for managing power from multiple distributors with electrical constraints. The embodiments provide a way to enable more variable (discretionary) load usage (e.g. more EV charging) than would normally be allowed with existing electrical distribution. It manages multiple electrical topologies, dynamically balancing loads, and respecting constraints at every level of the power distribution hierarchy.

There is provided controllers, methods and systems to allocate power (current) for use in a hierarchical power distribution network. A power distribution method allocates power proportionally based on load demand for variable loads, such as EV charging, as aggregated from distribution points and any power reserve available to allocate for such points. The allocation is constrained in accordance with electrical constraints of each of the respective distribution points for safe allocation. Parent and child controllers are shown and described, with feature configurable in each for easy installation and start up. A publish/subscribe protocol provides automatic network establishment. Systems and methods are applicable to various topologies including those at residential complexes (townhouses), campus and major venues.

Embodiments herein provide examples of:

A hierarchical group of independent topologies to exchange power allocation data and sensor readings to protect the top level(s) of the topology hierarchy.

A peered group of independent topologies to exchange power allocation data and sensor readings to protect a virtualized (not sensed) top level of the topology hierarchy.

In the hierarchical group case, power allocation requests are passed from each “child” to the “parent” topology, and power allocation responses are passed from the “parent” to each “child” topology. The responses fairly apportion, e.g. in proportion to the total requests made, the parent's available power to each child, protecting the parent level of the topology hierarchy.

In the peered group case, power allocation requests are passed from each “peer” to the “peer manager” topology, and power allocation responses are passed from the “peer manager” to each “peer” topology. The peer manager is also a peer, and makes a power allocation to itself. The responses fairly apportion the virtualized top level's configured maximum power to each peer, protecting the top level of the topology hierarchy. The peering approach eliminates the need for the virtualized top level to be monitored using current sensors.

### BRIEF DESCRIPTION OF THE DRAWINGS

FIGS. 1A, 1B, 2 and 3 are respective schematic diagrams showing example topologies of electrical distribution systems or portions thereof including components of a multi-level electrical management system in accordance with respective embodiments.

FIG. 4 is a block diagram of a peer-based multi-level electrical management system in accordance with an embodiment.

FIGS. 5A to 5D are block diagrams of components of the peer-based multi-level electrical management system of FIG. 4 in accordance with an embodiment.

### DETAILED DESCRIPTION

Upgrading electrical infrastructure to meet EV charging demands can be prohibitively expensive and time-consuming, often costing tens of thousands of dollars for individual units and potentially millions for larger complexes or campuses. Limited electrical capacity exists in power distribution systems, from individual sub-panels to building-wide systems and even shared feeders across multiple structures. High costs and long lead times are associated with electrical infrastructure upgrades at any level. Inefficient use of available power across multiple units, buildings, or areas sharing a power source are common as is difficulty in managing power allocation across multiple hierarchical levels (e.g., feeder, building main panel, sub-panels, individual chargers).

There is a potential for overloading electrical systems when multiple EVs are charging simultaneously at different levels of the power distribution hierarchy. A lack of flexibility exists in power allocation to respond to varying demands and priorities within complex electrical systems.

Another emerging challenge relates to the integration of discretionary power sources (solar, battery storage, vehicle to home (V2H), vehicle to grid (V2G) or generically, “V2X”) into existing power management systems without compromising core safety features. There is difficulty in providing user flexibility for alternative energy sources while maintaining strict infrastructure controls and there is need for intelligent management of discretionary power sources that can be enabled or bypassed based on user preference.

There have been several attempts by others to address the challenges of managing EV charging in complex environments with limited electrical capacity. Global Maximum Load Balancing Systems distribute available power equally among connected EVs based on available power. A disadvantage of such systems is the inefficient use of power when vehicles have different charging needs. They are unable to account for varying constraints at different levels of the electrical system. Building Energy Management Systems (BEMS) with EV Integration purport to integrate EV charging into overall building energy management. A disadvantage of such systems is they lack scalability to multi-building or campus environments. They also lack the fine-grained control of individual chargers and cannot address complex hierarchical constraints. On/Off Control Systems manage charging based on/off control at the circuit level and use a signal for feeder monitoring. A disadvantage of such systems is the simple on/off controls rather than fine-grained power allocation. These lack the ability to optimize energy usage across multiple levels simultaneously and are not scalable.

While these approaches address some aspects of the problem, they generally lack the comprehensive, hierarchical, and scalable approach needed to efficiently manage power across complex multi-level systems. They often fail to provide the flexibility required to optimize power usage while meeting diverse user needs in varied environments like multi-unit buildings, campuses, or communities with shared electrical infrastructure.

As shown in various embodiments, methods, systems, apparatus and techniques herein solve problems and overcome disadvantages of prior attempts through a comprehensive, hierarchical, and dynamic approach to power management for EV charging.

1. Hierarchical Variable Power Management: Implements a multi-level system that can manage power constraints at various levels (e.g., feeder, building, sub-panel, charger). Allows for fine-grained control of EV Chargers and optimization at each level of the electrical distribution system. Overcomes the limitations of simple load switching or feeder-level control systems On/Off) by providing variable control to every charger.

2. Real-Time Dynamic Power Allocation: Continuously monitors power usage at multiple levels using Sensor Samplers. Dynamically adjusts power by integrating with the EV or EV database based on real-time data, rather than simple on/off controls. Maximizes the use of available power by allocating it efficiently across all levels of the system, addressing the inefficiencies of static circuit sharing and time-of-use scheduling.

3. Modular and Scalable Architecture: Uses a modular approach with components like Peer Managers, Child Managers, and Charger Managers. Easily scales from single buildings with multiple sub-panels to large campuses or communities, overcoming the limitations of building-specific energy management systems.

4. Constraint Management at Multiple Levels: Considers and respects constraints at every level of the electrical infrastructure and distribution. Enables efficient power allocation within the limits of transformers, panels, circuits, and phases. Overcomes the shortcomings of systems that only manage constraints at a single level.

5. Discretionary Power Controller: Introduces concept of discretionary power for managing optional power sources (e.g. Solar). On/Off selection within the Discretionary Power Controller that create a constraint based on power available from an alternative source. Enabling a Discretionary Power Controller, the device will report to a parent controller that controls the available power coming from an alternative source.

Maintains core safety features while allowing flexible integration of solar, battery storage, and V2X. Enables user preference-based power source selection without compromising system safety

6. Peer-to-Peer, Parent-Child Communication and Discretionary Power Source: Utilizes Local area networks and internet protocols between system components at different levels. Enables coordinated decision-making across all levels of the hierarchy, addressing the limitations of isolated control systems.

7. Virtual Constraints Implementation: Allows for the creation and management of virtual power constraints across groups of devices or buildings. Provides flexibility in managing power allocation that goes beyond physical infrastructure limitations.

8. Priority Management: Incorporates priority management to balance EV charging needs with other electrical loads. Can be programmed to respect user preferences and priorities within the constraints of the system at multiple levels. Manages prioritization of discretionary power sources (e.g., solar-first charging). Enables override capabilities for Discretionary Power Source while maintaining system safety. Provides flexible power source selection based on user preferences and availability.

9. Scalability and Adaptability: The system can be applied to various scales and configurations, from single buildings to large campuses or neighborhoods. Overcomes the limitations of solutions designed for specific scales or types of installations.

By addressing at least some of these aspects, the invention overcomes the disadvantages of prior attempts. It provides a more comprehensive and flexible solution for managing power loads across various levels of electrical infrastructure constraints, optimizing power usage while respecting system limitations and user needs. This approach allows for efficient power management across complex, multi-level systems, adapting to various environments and maximizing the use of available electrical capacity.

The introduction of discretionary power source provides users with the flexibility to integrate alternative power sources while maintaining the robust safety features of the core system. This approach allows for maximizing both existing electrical infrastructure and renewable energy sources, providing a more comprehensive solution than previous attempts that either ignored alternative power sources or failed to integrate them safely.

This invention presents a hierarchical, edge-enabled system for dynamic allocation of electricity across multiple levels of power distribution infrastructure. The system utilizes a network of IoT-enabled current transformers and edge computing devices or external data sources to continuously monitor and process real-time power usage data at various levels, from individual chargers to building-wide systems and beyond.

The architecture comprises several modules, including a Peer Manager for coordinating power allocation among devices at the same hierarchical level, a Peer Reporter for reporting power and taking commands from a Peer Manager, a Child Manager for distributing allocations to lower levels, a Child Reporter for reporting power and taking commands from a Child Manager, and a Charger Manager for adjusting individual EV charging rates. In an embodiment, a central database (data server) aggregates data from a system for analysis and reporting.

The system differentiates between standard electrical infrastructure and discretionary power sources within its Parent/Child framework. Discretionary Power Limit Controllers manage optional power sources such as solar arrays, battery storage systems, and other supplementary energy connections. These controllers can be selectively enabled or disabled based on user preferences while maintaining strict adherence to infrastructure safety limits. When a Discretionary Power Limit Controller is disabled, the system continues to allow use of alternative power sources but removes their constraints from EV charging decisions. For example, in a townhouse with a solar array, enabling the controller would restrict EV charging to only use available solar power (shared between home consumption and charging). Conversely, disabling the controller could allow the EV to draw power from the standard electrical panel and other hierarchical sources, while still respecting their associated safety constraints. This flexible approach ensures users can optimize their charging preferences while maintaining system safety at all levels of the power distribution hierarchy.

The system employs a sophisticated communication framework to facilitate real-time data exchange between components, enabling coordinated decision-making across all levels of the hierarchy. A virtual constraint engine allows for flexible power management beyond physical infrastructure limitations, while a priority management system balances EV charging needs with other electrical loads and user preferences.

Key features include multi-phase (A, B, C) power management, standard and discretionary power limit management, ongoing integration of new peers and children, and failsafe mechanisms to prevent overloading. The system's modular and scalable design allows for flexible configuration across various infrastructure setups, from individual chargers to complex multi-building environments.

The following is a list of the components, along with their purpose and function:

### Hierarchical Control System

Purpose: Manage power allocation across multiple levels of electrical infrastructure.

Function: Coordinates power distribution decisions from the highest level where constraints exist down to individual chargers.

### Edge Computing Devices

Purpose: Provide local processing and decision-making capabilities.

Function: Collect and process data locally, reducing latency and enhancing system responsiveness.

### Current Transformers (CTs)

Purpose: Accurately measure current flow at various points in the electrical system.

Function: Provide real-time current measurements to the Sensor Sampler Module.

### Sensor Sampler Module

Purpose: Collect and aggregate real-time power usage data at various levels of the electrical system.

Function: Continuously collect and analyze power consumption from CTs and/or data sources, providing crucial input for decision-making.

### Peer Manager Module

Purpose: Coordinate power allocation among devices at the same hierarchical level.

Function: Share information and make collective decisions to optimize power usage within a given level.

### Discretionary Power Limit Manager

Purpose: Manage optional power sources within the parent-child management framework.

Function: Enable/disable discretionary power sources based on availability and user preferences. Monitor and report discretionary power availability. Handle override requests within infrastructure constraints.

### Reports to Peer Manager

Purpose: Provide real-time data from peer devices to the Peer Manager.

Function: Transmit sensor data, power usage, and allocation requests to enable informed decision-making at the peer level.

### Child Manager Module

Purpose: Manage power allocation to lower-level devices or subsystems.

Function: Receive instructions from higher levels and distribute power allocations to child devices.

### Reports to Child Manager System

Purpose: Provide real-time data from child devices to the Child Manager.

Function: Transmit sensor data, power usage, and allocation requests to enable informed decision-making for child device management.

### Communication Framework

Purpose: Enable efficient data exchange between all system components.

Function: Facilitate real-time communication of power availability, constraints, and allocation decisions.

### Central Data Processing

Purpose: Analyze aggregated data and report.

Function: Receive and process data from components of hierarchical system including peer and child components.

### Virtual Constraint Engine (e.g. in Peer and Child Managers)

Purpose: Implement and manage virtual power constraints.

Function: Allow for flexible power management beyond physical infrastructure limitations (this would be to set a limit on power that can be used. For example, to reduce power chargers from the electrical utility).

### Power Management Algorithm (e.g. in an OCPP Manager (Open Charge Point Protocol) Responsive to Constraints from Other Controller)

Purpose: Balance EV charging needs with other electrical loads, user preferences, and discretionary power sources.

Function: Assign and adjust priorities for power allocation based on predefined rules, real-time conditions and power source preferences (grid vs discretionary).

Handle override requests for user preferences.

### Charger Manager Module

Purpose: Control individual EV chargers.

Function: Adjust charging rates based on instructions from higher-level modules and local conditions.

### Local Data Storage and Processing Unit (e.g. Per Each Peer and Child Component)

Purpose: Store and process data locally at each level.

Function: Enable edge analytics and provide data redundancy.

### User Interface Module

Purpose: Allow system configuration, preference management and monitoring.

Function: Provide interfaces for setting constraints, priorities, discretionary power source configurations and viewing system status.

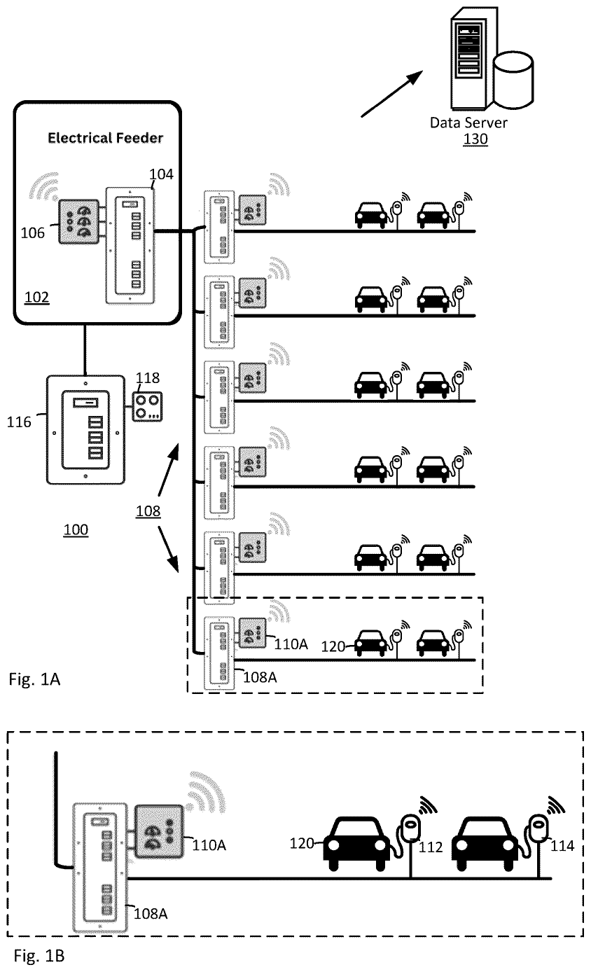

FIGS. 1A, 1B, 2 and 3 are respective schematic diagrams showing example topologies of electrical distribution systems or portions thereof including components of a multi-level electrical management system in accordance with respective embodiments. FIG. 1A illustrates a hierarchical power management system 100 in an embodiment having an electrical feeder 102 rated at 400 A having a distribution panel 104 coupled with a first level power management component 106. Feeder 102 is coupled to a plurality of townhouse panels (sub-panels) 108 each rated at 100 A. Each of the plurality sub-panels 108, e.g. 108A, which is shown in an enlargement in FIG. 1B is coupled with a second level power management component 110A. Each of the plurality of sub-panels is coupled with respective controlled loads. In the illustrated embodiment the controlled loads are chargers for electric vehicles (e.g. 112 and 114). Though a pair of such loads is shown for each panel, other arrangements are contemplated. The electric chargers are configured with at least power sensing capabilities and communication subsystem (e.g. wireless) to measure and report power information to the second level power management component (e.g. 110) associated with the sub-panel (e.g. 108A) to which the charger is coupled.

In the embodiment, electrical feeder 102 also services a subpanel 116 coupled to an uncontrolled load 118.

In accordance with embodiments as further described, each of the second level power management components (e.g. 110) is configured with power management capabilities and a communication sub-system to receive power information from the chargers and to communicate power information with the first level power management component 106 (e.g. transmitting information to and receiving information from) as further described for managing the sub-panel and allocating power for the controlled loads e.g. charging the electric vehicles (e.g. 120)

In accordance with embodiment, the first level power management component 108 is configured with power management capabilities and a communication sub-system to communicate power information with the second level power management components (e.g. transmitting information to and receiving information from) as further described for managing the sub-panels and allocating power for the controlled loads e.g. charging the electric vehicles (e.g. 120).

In accordance with an embodiment, components 106 and 108 communicate data to a data server 130 for aggregation, processing and reporting.

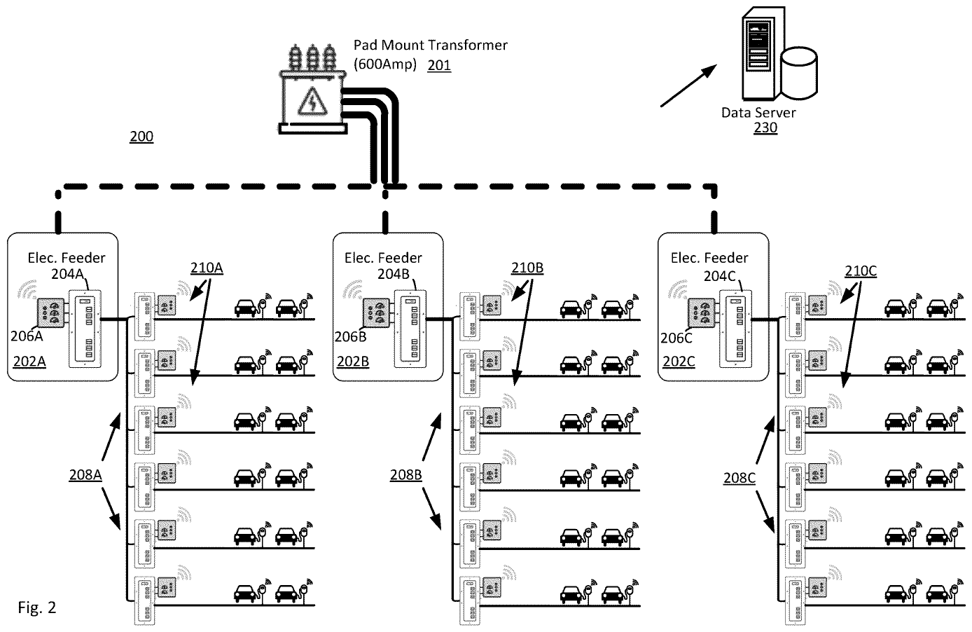

FIG. 2 illustrates a peer-to-peer power management system 200 in an embodiment to distribute power from a transformer (e.g. a pad mount transformer rated at 600 A) via a plurality of electrical feeders 202A, 202B and 202C.

Each feeder (e.g. 202A), e.g. rated at 400 A, comprises a distribution panel (e.g. 204A, 204B, 204C) and a first level power management components (e.g. 206A, 206B and 206C). In an embodiment, one of the first level power management components (e.g. 204A) provides a peer manager function for the others (e.g. 206B and 206C) and all the first level power management components (206A, 206B and 206C) provides child manager functions as further described for the respective plurality of sub-panels 208A, 208B and 208C and second level power management components (210A, 210B and 210C) to which they are respectively coupled. The second level power management components 210A, 210B and 210C are similar to component 110A as further described. In accordance with an embodiment, components 204A-204C and 210A-210B communicate data to a data server 230 for aggregation, processing and reporting.

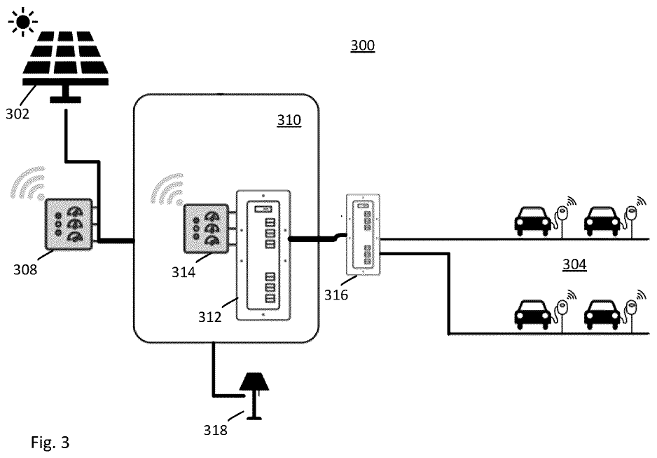

FIG. 3 illustrates a hierarchical power management system 300 in an embodiment such as for managing power at a location such as a residence having a discretionary power source 302 such as solar as well as controlled loads 304 such as electrical vehicle charging stations.

System 300 shows the discretionary power source 302 coupled to a first level power management component 308 as well as shows the source 302 is coupled to a primary power distributor 310 having a panel 312 e.g. rated at 200 A coupled with a second level power management component 314. Panel provides power to a sub-panel 316 for the controlled loads and also power to uncontrolled loads (e.g. 318).

In an embodiment of system 300, the second level power management component 314 reports information to the first level power management component 308. The first level power management component 308 reports a reserve to the second level power management component. When sufficient solar power is available, EVs can be charged and EVs won't be charged without solar power.

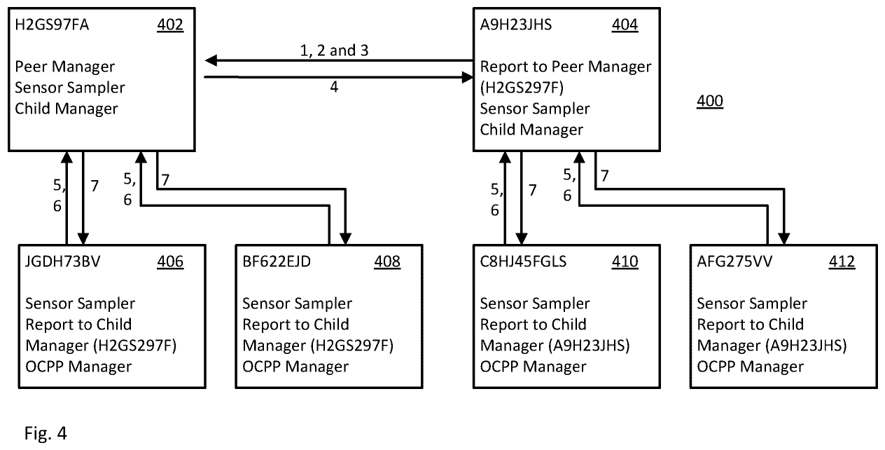

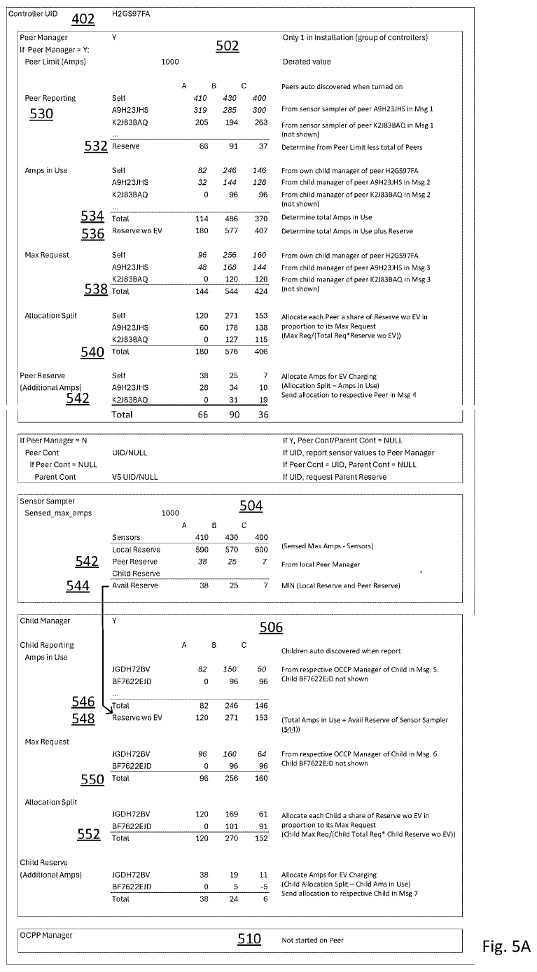

FIG. 4 is a block diagram of a peer-based multi-level electrical management system 400 in accordance with an embodiment. It is simplified as will be apparent and is similar to the schematic illustration of FIG. 2 but with fewer components shown. FIG. 4 shows first level and second level components in two way communication. A controller having an ID=H2GS97FA (402) is coupled in a peer-to-peer relationship with a controller having an ID=A9H23JHS (404). Though not shown in FIG. 4, controller 402 is also in a peer-to-peer relationship (and communicating) with a controller having an ID=K2J83BAQ.

In the embodiment, controller 402 provides peer manager functions to the first level components (e.g. 404) to which it is coupled. It also provides child manager functions to second level components (e.g. controllers 406 and 408) to which it is coupled. Controller 404 provides child manager functions to second level components (e.g. 410 and 412) to which it is coupled.

Each of the first and second level components (402-412) in the embodiment also provide sensor sampler functions to sense power (in three phases (A, B, C)) from a power source. Second level components (e.g. 406, 408, 410 and 412) also provide OCPP manager functionality for allocating power to respective controlled loads to which they are coupled such as EV chargers. OCPP is a communication protocol for EV charging stations and a management system e.g. in a charging station network. In an embodiment, the controllers (the first and second level components (402-412)) are coupled for communication via middleware in accordance with a messaging protocol. In an example the communication is implemented as a lightweight, publish-subscribe machine network protocol for message queue/message queuing (e.g. MQTT).

In an embodiment, controller 402 is similar to component 206A of FIG. 2 while the second level components 406 and 408 coupled thereto are similar to ones of components 210A. Controller 404 is similar to first level component 206B and while the second level components 410 and 412 coupled thereto are similar to ones of components 210B.

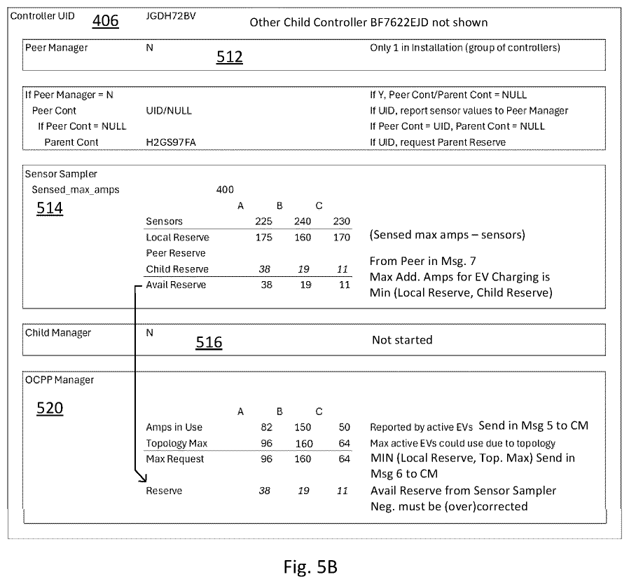

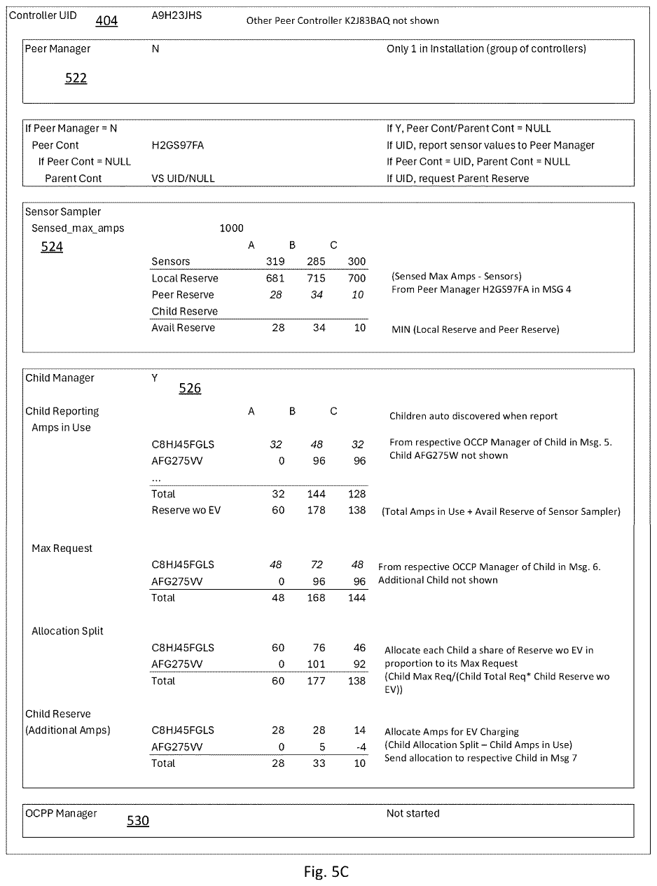

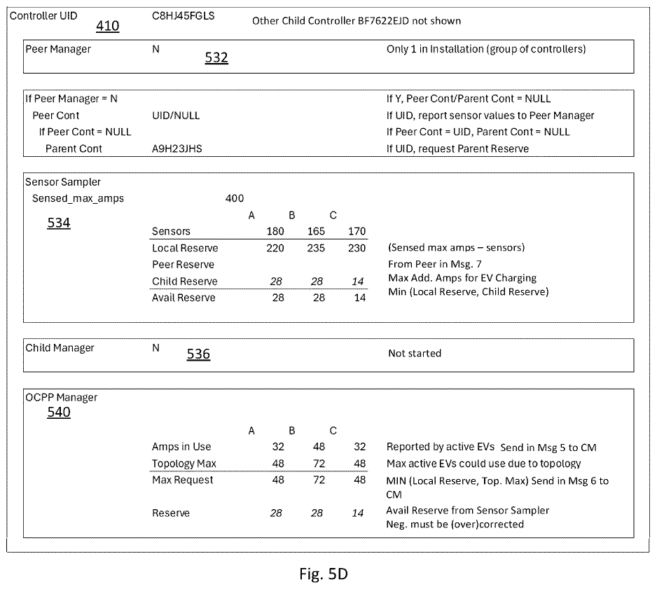

FIGS. 5A-5D show aspects of peer manager 502, 512, 522 sensor sampler 504, 514, 524 child manager 506, 516, 526 and OCPP manager 510, 520, 530 functions of controllers 402, 406, 404 and 410, respectively. In an embodiment, the controllers can be configured with all of the functions but only have selected functions activated when installed. Any controller may have the capability to act as a peer manager but not have the function activated, instead reporting to another controller that is activated as a peer manager. Child managers and children can be similarly activated. Peers and children can be discovered/determined using publish and subscription functionality.

With reference to FIG. 4 and FIGS. 5A-5D, first level controllers (e.g. 404) that report information to the peer manager send the following information in respective messages: Msg 1—sensed power from sensor sampler at the peer controller; Msg 2—current in use from child manager of the peer controller, Msg 3—maximum current request from child manager of the peer controller; and receive the following information in a message Msg 4 additional allocated power determined by the peer manager.

Second level controllers (e.g. 406-412) that report information to a child manager of a first level controller (e.g. 402 or 404) send the following information in respective messages Msg 5—current in use from OCPP manager of the child controller; and Msg 6—maximum current request from OCPP manager of the child controller; and receive the following information in a message: Msg 7—additional allocated power determined by the child manager.

With reference to FIG. 5A, in an embodiment, a peer manager 502 for itself and the peer controllers determines: sensed power 530 e.g. from peer sensors and as reported to the peer manager; a reserve or peer limit 532 using a power rating of the power source; a total current in use 534; a total plus the additional reserve 536; a maximum power request 538.

The peer manager 502 determines allocation of additional power for itself and the other peers, e.g. for sharing to respective children of itself and the other peers. FIG. 5A shows an allocation split 540 as a share of the reserve without EV in proportion to its maximum request as Max Request/(Total Request*Reserve without EV). The peer manager determines the additional amps or peer reserved to send. The additional amps is determined from the allocation split less the amps in use. This is sent to the peers of controller 402.

FIG. 5A also shows sensor sampler 504 determining available reserve information 544 using sensed power available, local reserve (sensed power less power in use) and peer reserve (from Peer Manager). The available reserve is the lesser of the local and peer reserves.

FIG. 5A shows child manager 506 determining a total current in use 546, as a sum of the power in use by its children, and a reserve with EV 548 as a total in use plus the available reserve of the sensor sampler.

Child manager 506 also determines a maximum request of current 550 from its children and determines an allocation split 552 of a share of the reserve without EV 548 in proportion to its maximum request 550. Additional amps 554, determined from the allocation less amount in use, is communicated to the respective child. The OCPP manger 510 is not activated on this first level controller 402 acting as a peer manager.

FIG. 5B shows peer manager 512 (not activated), sensor sampler 514, child manager 516 (not activated) and OCPP manager 520 operations for one of the second level controllers of FIG. 4, namely controller 406. The others function similarly but have their own respective sensor information and maximum requests.

Sensor sampler 514 determines a local reserve from sensed power in use and the rating (e.g. 400). The available reserve is determined, taking into account the child reserve received from the child manager. The OCPP manager is showing the maps in use by the EVs, which is communicated to the child manager to which the controller reports. The maximum request is determined as a minimum of the local reserve and the maximum that active EVs could use in the local topology. This is communicated to the child manager.

FIG. 5C shows peer manager 522 (not activated), sensor sampler 524, child manager 526 and OCPP manager 520 (not activated) operations for one of the first level controllers of FIG. 4, namely controller 404, that is not acting as the peer manager. The other similarly configured first level controllers function similarly but have their own respective sensor information and children, etc. The sensor sampler 524 and child manager 526 are similar to those of controller 402 but where the sensor sampler 524 receives respective peer reserve information 542 from controller 402.

FIG. 5D shows peer manager 532 (not activated), sensor sampler 534, child manager 536 (not activated) and OCPP manager 540 operations for one of the second level controllers of FIG. 4, namely controller 410, similar to controller 406 but has its own respective sensor information and maximum requests. The other second level controllers coupled to first level controller 404 also function similarly but have their own respective sensor information and maximum requests.

The illustrated embodiments show a hierarchical power management system for dynamically allocating electricity across multiple levels of power distribution infrastructure. One or more Peer Manager modules coordinate power allocation among devices at the same hierarchical level, including peer discovery and reserve calculation. One or more Child Manager modules manages power allocation to lower-level devices, including child discovery and reserve distribution.

In some embodiments, a Discretionary Power Limit Manager manages optional power sources within the peer management framework.

Sensor samplers perform real-time sensor sampling and data aggregation for continuous monitoring of power usage across multiple levels.

A dynamic allocation algorithm (executed by a Peer manager, for example) distributes available power reserves proportionally based on maximum requests from peers and children.

In an embodiments, components communicate in a wireless communication framework for real-time data exchange between system components across different hierarchical levels.

The modular architecture allows for flexible configuration of Peer Managers, Child Managers, and OCPP Managers based on device type and role. For example, in an embodiment, devices are configured with applicable programming and other components for any or all functionality. A particular device is configured to provide selected functionality for example as a Peer manger or a Child Manager, etc. In an embodiment, such as through publish-subscribe communications, the components can identify to other components and identify the other components in the hierarchical system. The components then communicate respective information accordingly, with child components reporting up and receiving reserve distribution information down, etc.

The power distribution algorithm can provide a method for calculating and distributing additional amperage (reserve) for EV charging across multiple levels of the hierarchy.

It will be appreciated that the system provides a scalable system design that can manage power allocation from individual chargers to building-wide systems and beyond.

Virtual constraint implementation allowing for management of power allocation beyond physical infrastructure limitations, including intelligent management of discretionary power sources

Multi-phase (A, B, C) power management capabilities, ensuring balanced allocation across all phases. Embodiments can provide for two or three phase management, for example.

The power distribution allocation provides a failsafe mechanisms to prevent overloading, including negative reserve correction. Further enabled is the ability to implement both physical and virtual power constraints within the hierarchical system.

The controllers with (activated) OCPP Managers provide integration with Open Charge Point Protocol for standardized communication with EV chargers.

Persons of ordinary skill in the art will recognize one or more other benefits from the disclosed embodiments, including but not limited to the following. Embodiments provide a hierarchical power management system that can efficiently manage power to EV chargers respecting electrical constraints across various levels of electrical distribution, from individual sub-panels to multi-building campuses. Diverse environments are enabled to support EV charging without requiring costly electrical upgrades. Embodiments are scalable and modular that can be easily adapted to different configurations and power constraints, whether in a single building or across multiple structures. Embodiments implement real-time monitoring and dynamic power allocation to maximize the use of available electrical capacity at each level of the hierarchy. And embodiments implement multiple constraints management for power flows, considering limitations of transformers, panels, circuits, phases, and other components of the electrical system.

Embodiments integrate priority management to ensure non-EV loads are not compromised by EV charging demands at any level of the system. Embodiments provide a system that can help home owners, building owners, property managers and utilities manage demand charges and support overall grid stability in various settings.

A communication framework for the controller components allows for efficient data exchange and control across various system components, regardless of the physical layout or scale of the installation.

Embodiments provide a framework for integrating discretionary power sources that maintains system safety. A hierarchical system herein can prioritize DERs (solar, battery, V2X) based on availability and user preferences.

In addition to computing device and method aspects, a person of ordinary skill will understand that computer program product aspects are disclosed, where instructions are stored in a non-transient storage device (e.g. a memory, CD-ROM, DVD-ROM, disc, etc.) and that, when executed, the instructions cause a computing device to perform any of the method aspects stored herein.

Some of the aspects and features will be understood from the following numbered statements:
Statement 1: A method of variable power allocation in a hierarchical power distribution network comprising a plurality of power distribution points in a hierarchical arrangement for the distribution of power to non-variable and variable loads, the method comprising: determining a reserve variable power amount available at a parent power distribution point for distribution to one or more child power distribution points for allocation to respective variable loads; determining a respective share of the reserve power amount for allocation by each respective child power distribution point to a respective variable load, the respective share allocated proportionally in accordance with each respective child power distribution point's respective maximum demand amount for variable power; and providing the respective share to a respective child power allocation controller for each respective child power distribution point for use to control of the allocation of the respective share to a respective load.

Statement 2: The method of Statement 1, wherein the reserve variable power amount comprises a variable power amount previously allocated as variable power in addition to any additional power amount at the parent power distribution point that is unallocated to non-variable power.

Statement 3: The method of Statement 1 or 2 comprising, for each respective child distribution point: receiving the respective maximum demand amount and a respective power amount previously allocated as variable power; and determining the respective share as a respective additional amount of power available for allocation to the respective child power distribution point.

Statement 4: The method of any one of Statements 1 to 3, wherein each respective child power allocation controller is configured to the control the allocation of the respective share to the respective load in response to a respective total load constraint of the respective child power distribution point.

Statement 5: The method of any one of Statements 1 to 4, wherein the hierarchical power distribution network comprises a plurality of parent power distribution points, each providing power from a common power source to one or more respective child power distribution points; each of the parent power distribution points is associated with a respective one of a plurality of peer power allocation controllers, one respective peer power allocation controller providing a peer manager function for all of the plurality of peer power allocation controllers; each of the respective child power distribution points is associated with a respective one of the one or more of child power allocation controllers; each of the peer allocation controllers provides a child manager function to one or more respective child power allocation controllers in accordance with the hierarchical arrangement of the network; and prior to step a), the peer manager function determines a respective peer reserve variable power amount available to each of the parent power distribution points in accordance with respective variable power amounts previously allocated as variable power by each of the peer power allocation controllers and any additional power amount available to the parent power distribution points that is unallocated to non-variable power by each of the peer power allocation controllers.

Statement 6: The method of Statement 5, wherein a respective peer share of the peer reserve variable power amount is allocated to each of the parent distribution points in proportion to respective peer maximum demands for variable power obtained from all the peer power allocation controllers.

Statement 7: The method of Statement 6, wherein each respective peer reserve variable power amount is provided to the respective child manager of the respective peer for use as the reserve variable power amount in step a).

Statement 8: The method of Statement 5 or 6, wherein the plurality of peer power allocation controllers and child power allocation controllers are configured to communicate to establish a network automatically using publish/subscribed network communication techniques.

Statement 9: The method of any one of the preceding Statements, wherein the hierarchical power distribution network comprises a secondary power source, optionally a renewable power source, that is local to the network, the secondary power source configured to provide additional power to the parent power distribution point in addition to a primary power source, and wherein the reserve variable power amount is determined in response to a power amount available from the renewable power source.

Statement 10: The method of Statement 9, wherein the secondary power source is a renewable power source only providing power occasionally and wherein the reserve variable power amount is determined only from the power amount of the renewable power source to allocate to the variable load.

Statement 11: The method of any one of the preceding Statements, wherein any one or more of: at least some of the variable loads comprise electric vehicle (EV) loads; each child power allocation controller is configured to communicate with a charging station to allocate the variable power, preferably communicating using Open Charge Point Protocol (OCPP); the hierarchical power distribution network provides power to any one of a residential complex having multiple units (optionally a townhouse complex), a hospital, educational institution or other campus, a commercial installation, a shopping mall, a sport venue, an amusement venue or the like; the hierarchical power distribution network is a multiphase network and the method is performed for each phase thereof; each peer power allocation controller is configured to selectively provide the peer manager function, the child manager function, a child function to report to a child manager, an OCPP manager function, and a sensor sampler function; each child power allocation controller is configured to selectively provide the peer manager function, the child manager function, a child function to report to a child manager, an OCPP manager function, and a sensor sampler function; or each controller is configured to provide data to a central database for processing and reporting.

Statement 12: A power allocation controller comprising: at least one processor coupled to one or more storage devices; and one or more interfaces for i) communication with other controllers; and ii) sense or measure power distribution related signals at a power distribution point; wherein the one or more storage devices store instructions executable by the at least one processor to cause the system to perform the method according to any one of the preceding Statements.

Statement 13A: A plurality of power allocation controllers in accordance with Statement 12 configured to control power allocation for a plurality of power distribution points of a hierarchical power distribution network. Statement 13B: The power allocation controller of Statement 12, wherein said controller comprises one of a plurality of such power allocation controllers, the plurality configured to control power allocation for a plurality of power distribution points of a hierarchical power distribution network

Statement 14: A method to configure a control of a hierarchical power distribution network, the method comprising: installing respective power allocation controllers in accordance with Statement 12 at respective power distribution points of the hierarchical power distribution network; configuring the respective power allocation controllers in accordance with specifications of the respective power distribution points, including power constraints, and the hierarchical arrangement of the network, including network topology such that at least two or more power allocation controllers are configured as child power allocation controllers to control allocation to the variable loads; and initiating the controllers to establish a network of controllers and to perform power allocation.

Statement 15: A method to allocate variable power in a hierarchical power distribution network having a plurality of distribution points in a hierarchical arrangement of levels, each distribution point having a respective electrical constraint, the method comprising: determining a reserve variable power amount for the plurality of distribution points, the reserve variable power amount responsive to a total available power amount for the plurality of distribution points less any amount allocated for non-variable loads; allocating, at each level of the hierarchical arrangement, respective shares of the reserve variable power amount to the plurality of distribution, wherein the allocating is in proportion to relative demand at each level and responsive to any respective electrical constraint for a particular distribution point to which the respective share is allocated; and distributing the reserve variable power to the variable loads in accordance with respective demands of the variable loads.

A feature of any method statement has an equivalent apparatus aspect such as a computing device, a system or a computer program product and vice versa.

Practical implementation may include any or all the features described herein. These and other aspects, features and various combinations may be expressed as methods, apparatus, systems, means for performing functions, program products, and in other ways, combining the features described herein. A number of embodiments have been described. Nevertheless, it will be understood that various modifications can be made without departing from the spirit and scope of the processes and techniques described herein. In addition, other steps can be provided, or steps can be eliminated, from the described process, and other components can be added to, or removed from, the described systems. Accordingly, other embodiments are within the scope of the following claims.

Throughout the description and claims of this specification, the word “comprise” and “contain” and variations of them mean “including but not limited to” and they are not intended to (and do not) exclude other components, integers or steps. Throughout this specification, the singular encompasses the plural unless the context requires otherwise. In particular, where the indefinite article is used, the specification is to be understood as contemplating plurality as well as singularity, unless the context requires otherwise.

Features, integers characteristics, compounds, chemical moieties or groups described in conjunction with a particular aspect, embodiment or example of the invention are to be understood to be applicable to any other aspect, embodiment or example unless incompatible therewith. All the features disclosed herein (including any accompanying claims, abstract and drawings), and/or all the steps of any method or process so disclosed, may be combined in any combination, except combinations where at least some of such features and/or steps are mutually exclusive. The invention is not restricted to the details of any foregoing examples or embodiments. The invention extends to any novel one, or any novel combination, of the features disclosed in this specification (including any accompanying claims, abstract and drawings) or to any novel one, or any novel combination, of the steps of any method or process disclosed.

What is claimed is:

1. A method of variable power allocation in a hierarchical power distribution network comprising a plurality of power distribution points in a hierarchical arrangement for the distribution of power to non-variable and variable loads, the method comprising:
determining a reserve variable power amount available at a parent power distribution point for distribution to one or more child power distribution points for allocation to respective variable loads;
determining a respective share of the reserve power amount for allocation by each respective child power distribution point to a respective variable load, the respective share allocated proportionally in accordance with each respective child power distribution point's respective maximum demand amount for variable power; and
providing the respective share to a respective child power allocation controller for each respective child power distribution point for use to control of the allocation of the respective share to a respective load.

2. The method of claim 1, wherein the reserve variable power amount comprises a variable power amount previously allocated as variable power in addition to any additional power amount at the parent power distribution point that is unallocated to non-variable power.

3. The method of claim 1 comprising, for each respective child distribution point:
receiving the respective maximum demand amount and a respective power amount previously allocated as variable power; and
determining the respective share as a respective additional amount of power available for allocation to the respective child power distribution point.

4. The method of claim 1, wherein each respective child power allocation controller is configured to the control the allocation of the respective share to the respective load in response to a respective total load constraint of the respective child power distribution point.

5. The method of claim 1, wherein:
the hierarchical power distribution network comprises a plurality of parent power distribution points, each providing power from a common power source to one or more respective child power distribution points;
each of the parent power distribution points is associated with a respective one of a plurality of peer power allocation controllers, one respective peer power allocation controller providing a peer manager function for all of the plurality of peer power allocation controllers;
each of the respective child power distribution points is associated with a respective one of the one or more of child power allocation controllers;
each of the peer allocation controllers provides a child manager function to one or more respective child power allocation controllers in accordance with the hierarchical arrangement of the network; and
prior to step a), the peer manager function determines a respective peer reserve variable power amount available to each of the parent power distribution points in accordance with respective variable power amounts previously allocated as variable power by each of the peer power allocation controllers and any additional power amount available to the parent power distribution points that is unallocated to non-variable power by each of the peer power allocation controllers.

6. The method of claim 5, wherein a respective peer share of the peer reserve variable power amount is allocated to each of the parent distribution points in proportion to respective peer maximum demands for variable power obtained from all the peer power allocation controllers.

7. The method of claim 6, wherein each respective peer reserve variable power amount is provided to the respective child manager of the respective peer for use as the reserve variable power amount in step a).

8. The method of claim 5, wherein the plurality of peer power allocation controllers and child power allocation controllers are configured to communicate to establish a network automatically using publish/subscribed network communication techniques.

9. The method of claim 1, wherein the hierarchical power distribution network comprises a secondary power source, that is local to the network, the secondary power source configured to provide additional power to the parent power distribution point in addition to a primary power source, and wherein the reserve variable power amount is determined in response to a power amount available from the renewable power source.

10. The method of claim 9, wherein the secondary power source is a renewable power source only providing power occasionally and wherein the reserve variable power amount is determined only from the power amount of the renewable power source to allocate to the variable load.

11. The method of claim 1, wherein any one or more of:
at least some of the variable loads comprise electric vehicle (EV) loads; or
each child power allocation controller is configured to communicate with a charging station to allocate the variable power, preferably communicating using Open Charge Point Protocol (OCPP).

12. The method of claim 1, wherein any one or more of:
the hierarchical power distribution network provides power to any one of a residential complex having multiple units, a hospital, educational institution or other campus, a commercial installation, a shopping mall, a sport venue, an amusement venue or the like.

13. The method of claim 1, wherein:
the hierarchical power distribution network is a multiphase network and the method is performed for each phase thereof.

14. The method of claim 1, wherein any one or more of:
each peer power allocation controller is configured to selectively provide the peer manager function, the child manager function, a child function to report to a child manager, an OCPP manager function, and a sensor sampler function; or
each child power allocation controller is configured to selectively provide the peer manager function, the child manager function, a child function to report to a child manager, an OCPP manager function, and a sensor sampler function.

15. The method of claim 1, wherein:
each controller is configured to provide data to a central database for processing and reporting.

16. A method to allocate variable power in a hierarchical power distribution network having a plurality of distribution points in a hierarchical arrangement of levels, each distribution point having a respective electrical constraint, the method comprising:
determining a reserve variable power amount for the plurality of distribution points, the reserve variable power amount responsive to a total available power amount for the plurality of distribution points less any amount allocated for non-variable loads;
allocating, at each level of the hierarchical arrangement, respective shares of the reserve variable power amount to the plurality of distribution, wherein the allocating is in proportion to relative demand at each level and responsive to any respective electrical constraint for a particular distribution point to which the respective share is allocated; and
distributing the reserve variable power to the variable loads in accordance with respective demands of the variable loads.

17. A power allocation controller comprising:
at least one processor coupled to one or more storage devices; and
one or more interfaces for i) communication with other controllers; and ii) sense or measure power distribution related signals at a power distribution point,
wherein the one or more storage devices store instructions executable by the at least one processor to cause the system to perform a method of variable power allocation in a hierarchical power distribution network comprising a plurality of power distribution points in a hierarchical arrangement for the distribution of power to non-variable and variable loads, the method comprising:
determining a reserve variable power amount available at a parent power distribution point for distribution to one or more child power distribution points for allocation to respective variable loads;
determining a respective share of the reserve power amount for allocation by each respective child power distribution point to a respective variable load, the respective share allocated proportionally in accordance with each respective child power distribution point's respective maximum demand amount for variable power; and
providing the respective share to a respective child power allocation controller for each respective child power distribution point for use to control of the allocation of the respective share to a respective load.

18. The power allocation controller of claim 17, wherein said controller comprises one of a plurality of such power allocation controllers, the plurality configured to control power allocation for a plurality of power distribution points of a hierarchical power distribution network.

19. A method to configure a control of a hierarchical power distribution network, the method comprising:
installing respective power allocation controllers, each in accordance with claim 17, at respective power distribution points of the hierarchical power distribution network;
configuring the respective power allocation controllers in accordance with specifications of the respective power distribution points, including power constraints, and the hierarchical arrangement of the network, including network topology such that at least two or more power allocation controllers are configured as child power allocation controllers to control allocation to the variable loads; and
initiating the controllers to establish a network of controllers and to perform power allocation.
